(19) United States
(12) Patent Application Publication
(10) Pub. No.: US 2007/0087265 A1
(43) Pub. Date: Apr. 19, 2007

(54) Lithium battery

(76) Inventors: Cheng-Yi Lai, Yunling Hsien (TW); Shih-Hang Chou, Nantou Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/251,815

(22) Filed: Oct. 18, 2005

(51) Int. Cl. H01M 6/30; H01M 4/50; H01M 4/58; H01M 4/52; H01M 2/18

(52) U.S. Cl. 429/110; 429/61; 429/231.1; 429/224; 429/223; 429/231.95; 429/231.3; 429/130

(57) ABSTRACT

A lithium battery includes a casing having at least one reacting trough in which at least one electrode device is installed and the at least one electrode device includes a first electrode having a lithium compound that contains ionizable lithium ions and a first electric conductor. A second electrode includes at least including a layer material containing carbon or metal alloys, and a second electric conductor. A third electrode is disposed between the first electrode and the second electrode. The third electrode has an electrically conductive carrier for electroplating lithium ions and the carrier has a penetrating hole for passing lithium ions through the penetrating hole. At least one isolating membrane separates the first, second and third electrodes. The isolating membrane including a small hole for passing ions through the small holes. A control device controls the switch of a charging or a discharging status of the first, second and third electrodes.

### FIELD OF THE INVENTION

The present invention relates to a lithium battery, and more particularly to a lithium battery that can be charged repeatedly and has double electric output.

### BACKGROUND OF THE INVENTION

Referring to FIG. 7 for a present lithium battery structure, the lithium battery structure comprises a casing with a reacting trough for containing the reactants of the lithium battery and at least one electrode device 120, but the electrode device 120 only includes a lithium compound capable of ionizing lithium ions, a first electrode 121 of a first electric conductor 121a, a layer material containing carbon element, and a second electrode 122 of a second electric conductor 122a. Since the prior art structure only has an anode and a cathode, therefore the battery can be discharged for one time only, and a secondary discharge for supply power is not possible. As a result, the power supply performance and the life of use of the battery cannot be enhanced.

The so-called secondary lithium battery simply refers to its discharge function, and thus the battery can be used repeatedly, but the prior art structure also comprises a lithium compound containing lithium ions, a first electrode 121 of a first electric conductor 121a, a layer material containing carbon element, and a second electrode 122 of a second electric conductor 122a, and the prior art structure only has an anode and a cathode. Therefore, the battery can be charged and discharged for one time only, and a secondary discharge for supplying power is impossible, and the power supply performance of the battery cannot be improved.

### SUMMARY OF THE INVENTION

Therefore, it is a primary objective of the present invention to provide a secondary lithium battery that can be charged and discharged for two times repeatedly.

The present invention provides a lithium battery which includes a casing having at least one reacting trough in which at least one electrode device is installed and the at least one electrode device includes a first electrode having a lithium compound that contains ionizable lithium ions and a first electric conductor. A second electrode includes at least including a layer material containing carbon or metal alloys, and a second electric conductor. A third electrode is disposed between the first electrode and the second electrode. The third electrode has an electrically conductive carrier for electroplating lithium ions and the carrier has a penetrating hole for passing lithium ions through the penetrating hole. At least one isolating membrane separates the first, second and third electrodes. The isolating membrane includes a small hole for passing ions through the small holes. A control device controls the switch of a charging or a discharging status of the first, second and third electrodes.

### BRIEF DESCRIPTION OF THE DRAWINGS

FIG. 1 is a schematic view of the disassembled parts of a basic structure of the present invention;

FIG. 2 is a schematic view of some of the dissembled parts of a basic structure of the present invention;

FIG. 3 is a perspective view of the present invention;

FIG. 4 is a cross-sectional view of an electrode device of the present invention;

FIG. 5 is a schematic view of an electrode device according to another preferred embodiment of the present invention;

FIG. 5A is a cross-sectional view of FIG. 5;

FIG. 6 is a schematic view of a basic structure according to another preferred embodiment of the present invention; and

FIG. 7 is a cross-sectional of a prior art electrode device structure.

### DETAILED DESCRIPTION OF THE PREFERRED EMBODIMENTS

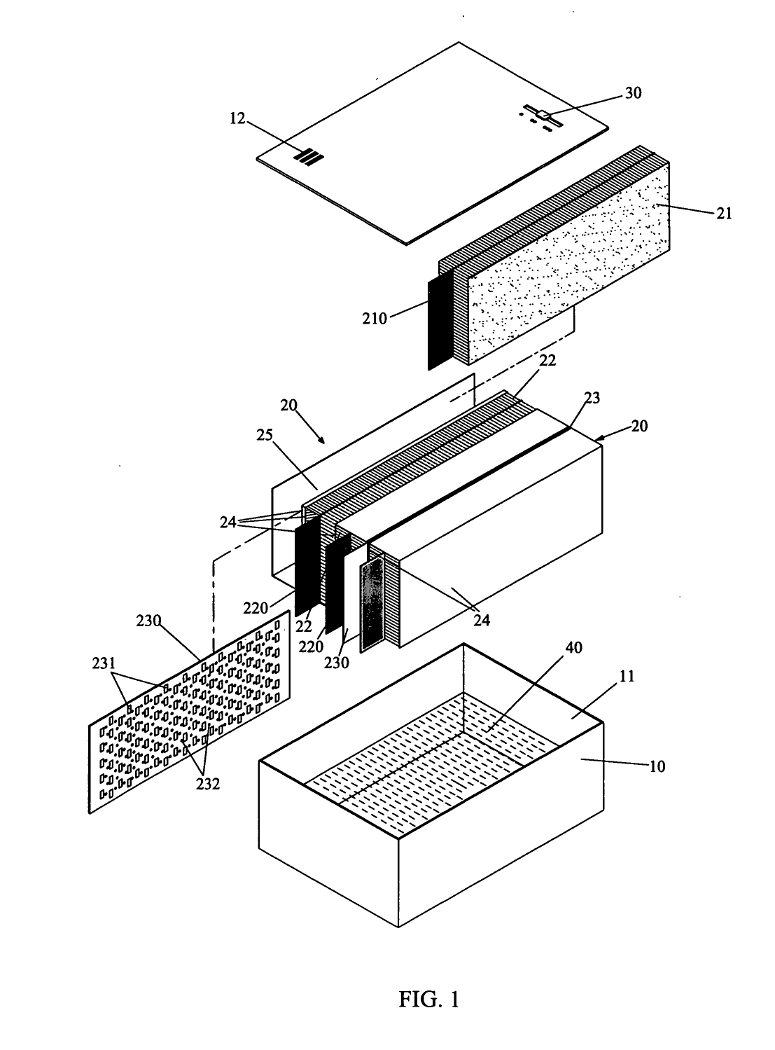

Referring to FIGS. 1, 2 and 4, a basic structure according to a preferred embodiment of the present invention comprises:

a casing 10, having at least one reacting trough 11 for containing a reactant 40 of the lithium battery;

at least one electrode device 20, installed in the reacting trough 11 of the casing 10, for carrying out an electric energy reaction with the reactant 40 of the lithium battery, and each electrode device 20 comprises:

a first electrode 21, at least including a lithium compound capable of ionizing lithium ions and a first electric conductor 210;

a second electrode 22, at least including a layer material that contains carbon element or metal compounds, and a second electric connector 220;

a third electrode 23, disposed between the first electrode 21 and the second electrode 22, and having an electrically conductive carrier 230 for plating lithium ions, and the carrier 230 includes penetrating holes 231 for passing lithium ions; and

at least one isolating membrane 24, for isolating the first electrode 21, the second electrode 22, and the third electrode 23, and the isolating membrane 24 includes a tiny hole for passing ions, wherein the preferred embodiment of the present invention comprises the following elements:

Several isolating membranes 24 according to the present preferred embodiment are extended integrally and enclosed into three containing grooves 25 for respectively containing the first electrode 21, the second electrode 22, and the third electrode 23, and the isolating membranes 24 are connected in sequence to form a continuous body with two free ends; and

a control device 30, for controlling the switch between charging and discharging of the first electrode 21, second electrode 22, and third electrode 23, so that the battery can achieve the purpose of doubling the power supply.

In the present preferred embodiment, the compound of the first electrode 21 could be lithium cobalt oxide, lithium manganese oxide, lithium nickel oxide, or lithium iron phosphate.

In the present preferred embodiment, the carrier 230 of the third electrode 23 is a sheet electric conductive thin membrane (not shown in the figure) made of copper, aluminum, silver, alloys, amalgam, stainless steel, or carbon fiber fabric.

Referring to FIG. 1 for the preferred embodiment of the present invention, the surface of carrier 230 includes small lumpy sections 232 for increasing the surface of attaching lithium ions.

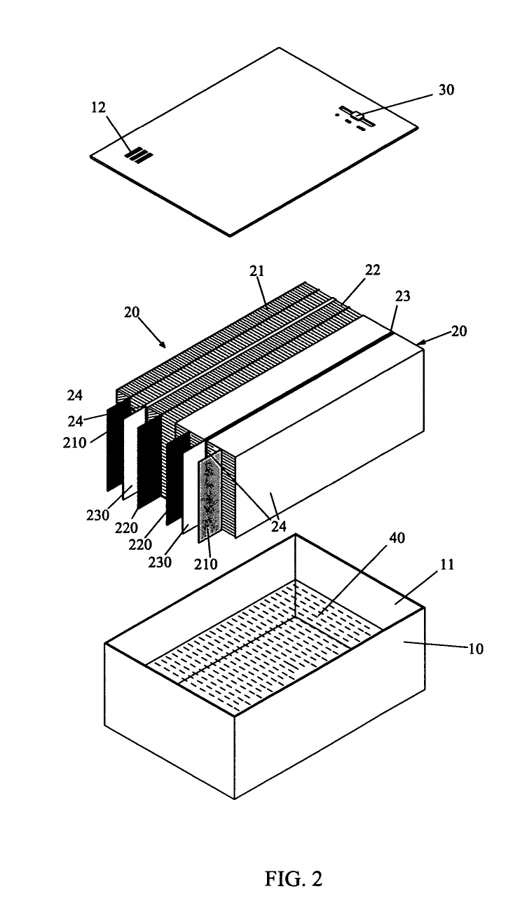

Referring to FIGS. 1 and 2 for the preferred embodiment of the present invention, the isolating membrane 24 is integrally surrounded between the first electrode 21 and the third electrode 23 as well as the third electrode 23 and the second electrode 22, and is a continuous body with two free ends, and the isolating membrane 24 is a porous thin membrane made of extracting and extending PP, PE, or other plastic materials.

Referring to FIGS. 1 to 3 for the preferred embodiment of the present invention, the control device 30 comprises a plurality of contact point flip-flop switches installed on the casing 10 and electrically connected to the first electrode 21, second electrode 22 and third electrode 23.

In the preferred embodiment of the present invention, if the control device 30 is charged, the first electrode 21 is electrically connected to the anode contact point of the power supply and the third electrode 23 is electrically connected to the cathode contact point of the power supply such that the first electrode 21 serves as an anode and the third electrode 23 serves as a cathode.

In the preferred embodiment of the present invention, if the control device 30 is discharged for the first time, the third electrode 23 is electrically connected to the anode contact point, and the second electrode 22 is electrically connected to the cathode contact point, such that the third electrode 23 serves as an anode and the second electrode 22 serves as a cathode.

In the preferred embodiment of the present invention, the control device 30 is discharged for the second time, the first electrode 21 is electrically connected to the anode contact point of the load 50 and the third electrode 23 is electrically and separately connected to the second electrode 22 and the cathode contact point of the load 50, such that the first electrode 21 serves as an anode and the third electrode 23 and second electrode 22 serve as cathodes.

In the preferred embodiment of the present invention, if the control device is discharged for the second time, the first electrode 21 is electrically connected to the anode contact point of the load 50 and the second electrode 22 is electrically connected to the cathode contact point of the load 50.

Referring to FIGS. 1 to 3, for the preferred embodiment of the present invention, the reacting trough 11 of the casing 10 comprises a plurality of electrode devices 20 arranged one next to the other, and each electrode device 20 includes the first electrode 21, the third electrode 23, and the second electrode 22 arranged in order, and the same first electrode 21 or second electrode 22 of two adjacent electrode devices 20 are arranged adjacent to each other, and an isolating membrane 24 is installed between every two adjacent electrodes. The isolating membrane 24 is a continuous body connected with each other in sequence with two free ends.

In the preferred embodiment of the present invention, the lithium battery reactant 40 can be a prior art solvent including propylene carbonate, ethylene carbonate, dimethyl carbonate, diethyl carbonate, methyl acetate, methyacrylate, and lithium salts including LiClO₄, LiBf₄, LiPf₆, or LiAsF₆ or liquid electrolytes formed according to a certain proportion, polymer electrolytes formed by lithium salts and polymers or plastic electrolytes formed by lithium salts.

Referring to FIGS. 1 to 3 for the preferred embodiment of the present invention, the casing 10 includes an electric conductive contact point 12 for charging or discharging.

In the preferred embodiment of the present invention, two or more lithium batteries are connected in series to increase power supply performance, and a multiple-point link switch (not shown in the figure) is used to electrically connect each electric conductive contact point 12 of the lithium batteries, and thus the link switch is used to control the link between the lithium batteries and achieve the objectives of charging and discharging the lithium batteries when they are connected in series.

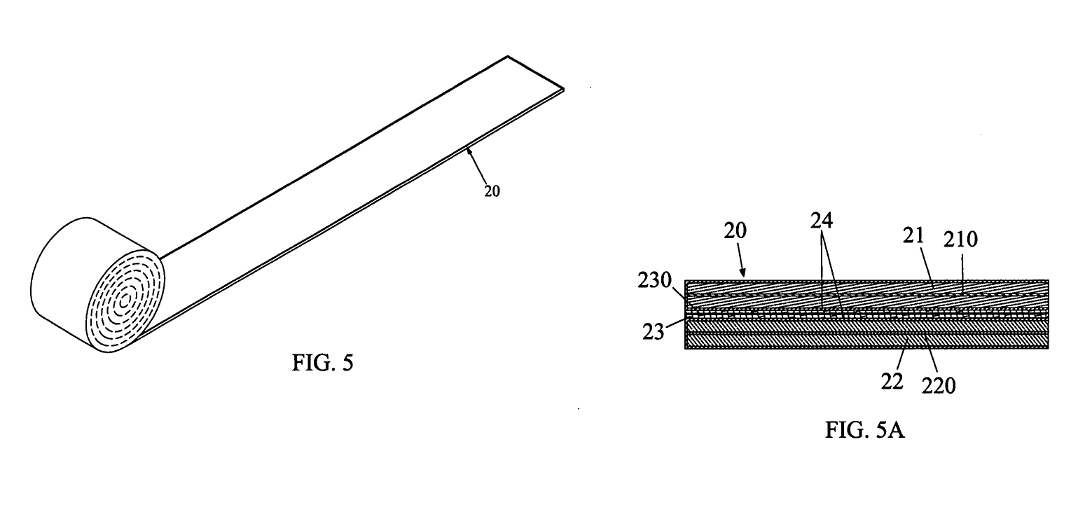

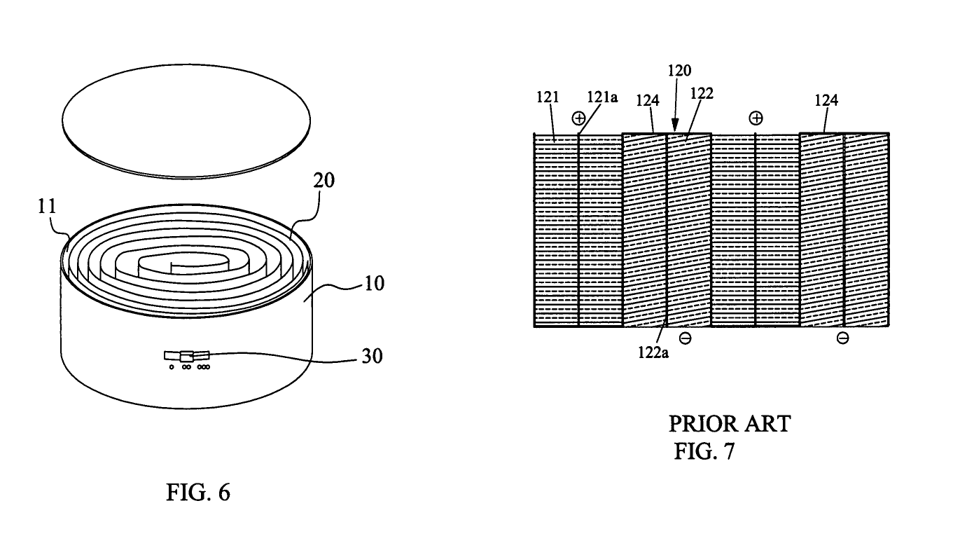

Referring to FIGS. 5, 5A and 6 for another preferred embodiment of the present invention, the electrode device 20 of the first electrode 21, second electrode 22 and third electrode 23 is made into a long bar to be coiled and placed into the reacting trough 11 of the circular casing 10.

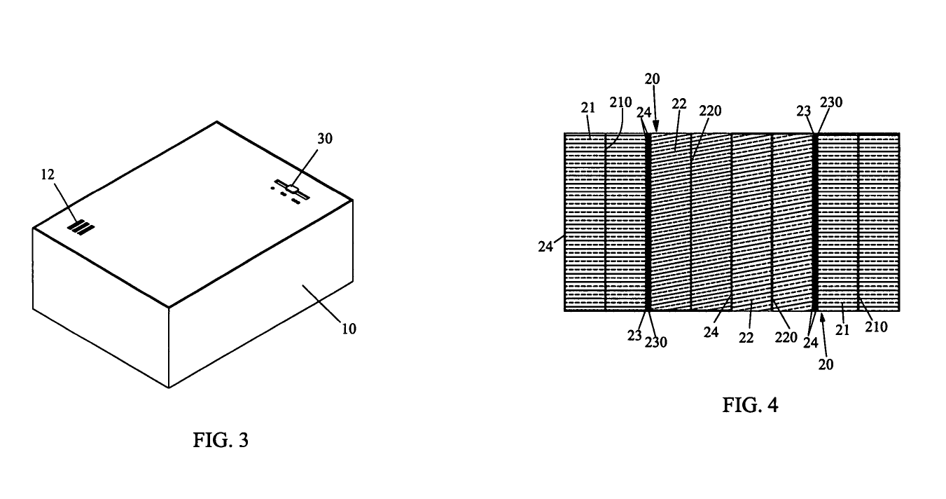

Referring to FIGS. 3 and 4 for the assembly of the preferred embodiment of the present invention, the isolating membrane 24 partitions the first electrode 21, second electrode 22 and third electrode 23 into electrode devices 20 stacked or compressed into the reacting trough 11 of the casing 10 containing the lithium battery reactant 40, and an electric conductive plate 210, 220, 230 of each electrode device 20 having he same electrode is connected with each other in parallel, and the electric conductive contact point 12 of the casing 10 is electrically connected to the electric conductive plate 210, 220, 230 of the electrode device 20, and finally a cover seals the casing 10 and completes the assembly of the present invention.

Referring to FIGS. 3 and 4 for the charging operation according to the present invention, the control device 30 of the casing 10 is switched to the charging position, so that the first electrode 21 is electrically connected to the anode contact point of the power supply, and the third electrode 23 is electrically connected to the cathode contact point of the power supply. According to the principle of electroplating, the first electrode 21 and the third electrode 23 for an electrode circuit, and thus the lithium ions in the first electrode 21 is electroplated onto the surface of the carrier 230. If the surface of the carrier 230 is electroplated completely with lithium ions, the battery is fully charged.

Referring to FIGS. 3 and 4 for the discharging operation for the first time, the control device 30 of the casing 10 is switched to the first-time discharging position, so that the third electrode 23 is electrically connected to the anode contact point of the load, and the second electrode 22 is electrically connected to the cathode contact point of the load. Now, the chlorate ion of the lithium battery reactant (LiClO₄) is combined with the lithium ion of the carrier of the third electrode 23 carrier into (Li+ClO₄) to release an electron to the second electrode, and the lithium ion of the lithium battery reactant (Li−ClO₄) is shifted to the second electrode to produce (Li+C). The chlorate and the lithium metal are combined to produce a chemical discharge reaction to achieve the first-time discharging effect.

After the first-time discharge is completed, the second-time discharge will be performed. The control device 30 of the casing 10 is switched to a second-time discharging position, so that the first electrode 21 is electrically connected to the anode contact point of the load, and the second electrode 22 and the third electrode 23 are electrically connected to the cathode contact point of the load. Since the third electrode 23 has combined with the lithium ion (C+Li ), the lithium ion starts separating the third electrode 23 and passing the penetrating hole 231 of the carrier 230 to combine with the cobalt compound (CoO₄) of the first electrode 21 to produce LiCoO₄ and discharges electricity. Therefore, the electric energy is produced among the first electrode 21 and the second electrode 22 and the third electrode 23, and the foregoing electric energy reaction is repeated to achieve the second-time discharge for doubling the output of power supply.

Further, the first electrode 21 can be electrically connected to the anode contact point of the load and the second electrode 22 is electrically connected to the cathode contact point of the load for the second-time discharge, so that the lithium battery also can achieve the second-time discharging effect and double the output of the power supply.

In summation of the description above, the design of the foregoing structure has the following advantages:

1. The present invention includes three electrodes and a control device, and thus can achieve the effect of doubling the output of electric energy of the battery and greatly improving the power supply performance and the life of the battery. The invention is definitely useful and commercially valuable.

2. Since the invention comes with three electrodes and a control device, therefore the using time of discharge can be extended and the shortcoming of consuming the electric power too fast in an outdoor environment can be improved. The invention can solve the problem of having a too-short battery time for the lithium battery.

What is claimed is:

1. A lithium battery, comprising:
a casing, having at least one reacting trough for containing a lithium battery reactant;
at least one electrode device, installed in the reacting trough of the electrode device for performing an electric energy reaction by the lithium battery reactant, and the each electrode device comprising:
a first electrode, at least including a lithium compound that contains ionizable lithium ions and a first electric conductor;
a second electrode, at least including a layer material containing carbon or metal alloys, and a second electric conductor;
a third electrode, disposed between the first electrode and the second electrode, and the third electrode having an electrically conductive carrier for electroplating lithium ions, and the carrier having a penetrating hole disposed thereon for passing lithium ions through the penetrating hole; and
at least one isolating membrane, for partitioning the first electrode, second electrode and third electrode, and the isolating membrane including a small hole for passing ions through the small holes; and
a control device, for controlling the switch of a charging or a discharging status of the first electrode, second electrode and third electrode, such that the lithium battery is capable of doubling the electric output of the lithium battery.

2. The lithium battery as claimed in claim 1, wherein the first electrode is a made of a compound of lithium cobalt oxide, lithium manganese oxide, lithium nickel oxide, or lithium iron phosphate.

3. The lithium battery as claimed in claim 1, wherein the carrier of the third electrode is made of a sheet electric conductive thin membrane made of copper, aluminum, tin, silver, metal alloys, amalgam, stainless steel, or carbon fiber fabric.

4. The lithium battery as claimed in claim 3, wherein the carrier includes a tiny lumpy section disposed on the surface of the carrier for increasing the area of attaching lithium ions.

5. The lithium battery as claimed in claim 1, wherein the isolating membrane is surrounded integrally between the first electrode and the third electrode, and between the third electrode and the second electrode to form a continuous body with two free ends, and the isolating membrane is a porous thin membrane made by extracting and extending PP, PE, or another plastic material.

6. The lithium battery as claimed in claim 1, further comprising a plurality of isolating membranes disposed in parallel with each other, and the plurality of isolating membranes are enclosed into three containing grooves for containing the first electrode, the second electrode and the third electrode, and the four isolating membranes are coupled in sequence to form a continuous body with two free ends.

7. The lithium battery as claimed in claim 1, wherein the control device is a flip-flop switch having a plurality of contact points and the flip-flop switch is installed on the casing and electrically connected the first electrode, the second electrode and the third electrode into a circuit.

8. The lithium battery as claimed in claim 1, wherein the first electrode is electrically coupled to an anode contact point of the power supply and the third electrode is electrically coupled to a cathode contact point of the power supply, when the control device is charged, so that the first electrode is electrically coupled to the anode contact point of the power supply and the third electrode is electrically coupled to the cathode contact point of the power supply.

9. The lithium battery as claimed in claim 1, wherein the third electrode is electrically coupled to an anode contact point of a load, and the second electrode is electrically coupled to a cathode contact point of the load, if the control device is discharged for the first time.

10. The lithium battery as claimed in claim 1, wherein the first electrode is electrically coupled to an anode contact point of a load and the third electrode is separately and electrically coupled to the second electrode and a cathode contact point of the load, if the control device is discharged for the second time.

11. The lithium battery as claimed in claim 1, wherein the first electrode is electrically coupled to an anode contact point of a load, and the second electrode is electrically coupled to a cathode contact point of the load, if the control device is discharged for the second time.

12. The lithium battery as claimed in claim 1, wherein the reacting trough of the casing comprises a plurality of electrode devices arranged one next to the other, and the each electrode device includes a first electrode, a third electrode, and a second electrode disposed in sequence, and the two adjacent electrode devices having the same first electrode or second electrode are disposed adjacent with each other, and an isolating member is disposed between every two adjacent electrodes, and the isolating membranes are coupled in series to form a continuous body with two free two ends.
